(19) United States
(12) Patent Application Publication
(10) Pub. No.: US 2021/0123000 A1
(43) Pub. Date: Apr. 29, 2021

(54) TRANSPARENT SOAP HAVING 3-DIMENSIONAL MESSAGE DISPLAYING FUNCTION AND METHOD FOR PRODUCING THE SAME

(71) Applicant: Kyung ho SONG, Cheonan (KR)

(72) Inventor: Kyung ho SONG, Cheonan (KR)

(21) Appl. No.: 16/670,995

(22) Filed: Oct. 31, 2019

(30) Foreign Application Priority Data
Oct. 23, 2019 (KR) 10-2019-0131848

(51) Int. Cl. C11D 17/04; C11D 13/16; C11D 17/00

(52) U.S. Cl. CPC C11D 17/04; G09F 23/00; C11D 17/0095; C11D 13/16

(57) ABSTRACT

Disclosed are a transparent soap and a method for producing the same, and more particularly to a transparent soap having a 3-dimensional message displaying function, which can realize variously expressible messages, such as a letter, a figure, or a picture, in the interior of the soap instead of the outer surface of the soap according to the tastes of the consumers to display the messages to the outside 3-dimensionally, and can properly exhibiting the cleaning function of the soap itself while eliminating the foreign feelings, and a method for producing the same.

### CROSS-REFERENCE TO RELATED APPLICATION

The present application claims priority under 35 U.S.C. § 119(a) to Korean Patent Application Number 10-2019-0131848, filed on Oct. 30, 2019, which is incorporated herein by reference in its entirety.

### BACKGROUND OF THE INVENTION

### 1. Field of the Invention

The present invention relates to a transparent soap and a method for producing the same, and more particularly to a transparent soap having a 3-dimensional message displaying function, which can realize variously expressible messages, such as a letter, a figure, or a picture, in the interior of the soap instead of the outer surface of the soap according to the tastes of the consumers to display the messages to the outside 3-dimensionally, and can properly exhibiting the cleaning function of the soap itself while eliminating the foreign feelings, and a method for producing the same.

### 2. Description of the Prior Art

In general, a soap is produced by performing a hydrolysis process on an animal and vegetable fat, such as beef tallow or palm oil to obtain a fatty acid or glycerin such as a palmitin acid or a stearin acid, neutralizing the obtained fatty acid to caustic soda or sodium carbonate, adding various additives, and processing the mixture. The soap products are classified into a cosmetic soap, a cleaning soap, an industrial soap, and a medical soap according to the purpose thereof. Among the soaps, a product, to which an anti-oxidation agent, a coloring agent, a spice, a stimulus lessening agent, a builder (sodium phosphate or sodium carbonate), and a moisturizing material are added, is called a cosmetic soap, and the cosmetic soap has a good order, has an appealing color, and an extremely mild property to skin, and rarely generates bubbles because a spice is added to the cosmetic soap.

In particular, if glycerin, sugar, or alcohol is added to the cosmetic sop, the soap becomes transparent, and unlike a general solid soap, the transparent soap has an excellent moisturizing property and transmits light to improve an aesthetic feeling, which increases the consumption of the transparent soaps.

In recent years, the transparent soaps on sale have been manufactured to provide an advertising effect by inserting a label, on which trademarks or advertising phases of a soap manufacturer or a soap B2B purchaser into a central portion of the interiors of the soaps in a coated state by using characteristics, by which the interiors of the soaps can be easily viewed transparently.

The transparent soap is called a “message soap”, and the soap is made generally by writing or printing various desired phases or pictures, by a user, on a surface of an insert including paper or a film through a manual operation before the soap is manufactured, and coating the surface thereof, and inserting it into a transparent soap liquid.

For example, Korean Utility Model No. 20-0480496 (Published on May 25, 2016) discloses a transparent soap which is manufactured by inserting an insert visually viewed to the outside into a transparent soap body, filling a transparent soap material of a liquid or a gel in a mold, in which the insert is accommodated, and solidifying the transparent soap material. The transparent soap provides an advertising effect by engraving advertising phrases on a surface of the insert, or allows a user to view his or her face by enlarging a specific portion of the face when shaving or washing the face by disposing a concave mirror in the transparent soap.

However, the transparent soap manufactured in this way or other message soaps has an effect of delivering a message expressed in various forms to the consumers, but as the real soap is worn out, the insert such as a paper or a film, on which the message is printed and coated is exposed to the outside, which restricts the cleaning function of the soap and causes the convenience of use.

### PRIOR TECHNICAL DOCUMENTS

### Patent Documents

Korean Utility Model Application Publication No. 20-1999-0035501 (published on Sep. 15, 1999)

Korean Utility Model No. 20-0222568 (Published on May 2, 2001)

Korean Patent Application Publication No. 10-2011-0018570 (published on Feb. 24, 2011)

Korean Utility Model No. 20-0480496 (Published on Jun. 1, 2016)

### SUMMARY OF THE INVENTION

The present invention has been made in an effort to solve the above-mentioned problems, and provides a transparent soap having a 3-dimensional message displaying function, which can realize variously expressible messages, such as a letter, a figure, or a picture, in the interior of the soap instead of the outer surface of the soap according to the tastes of the consumers to display the messages to the outside 3-dimensionally, and a method for producing the same

The present invention also provides a transparent soap having a 3-dimensional message displaying function, which can properly exhibiting the cleaning function of the soap itself while eliminating the foreign feelings of consumers by visually integrally forming an inner soap part providing a message displaying function and a transparent outer soap part of a liquid or a gel, which is filled around the inner soap part, and a method for producing the same

In accordance with an aspect of the present invention, a method for producing a transparent soap having a 3-dimensional message displaying function includes a step S1 of making a transparent inner soap part having a message, a step S2 of making an melted transparent outer soap part that is to be coupled to an outer surface of the inner soap part to be integrally formed with the inner soap part, and a step S3 of coupling the outer soap part to the inner soap part such that the outer soap part surrounds the outer surface of the inner soap part and integrally forming the outer soap part with the inner soap part.

In step S1, the message may be a printing matter in which an image or a letter of a natural substance, which has a bonding property, is printed such that the message is attached to the outer surface of the inner soap part.

Step S1 may include a step S11 of introducing a natural white soap base on sale into a double boiler, and heating the double boiler to melt the natural white soap base, a step S12 of introducing the melted soap base into a specific frame and solidifying the melted soap base at a room temperature for two or three days to generate an inner soap matrix, a step S13 of engraving a message on a surface of the generated inner soap matrix by using a laser machine programmed in advance, a step S14 of removing foreign substances residing on the surface of the inner soap matrix, on which the message is engraved, a step S15 of, after step S14, pouring charcoal powder onto the outer surface of the inner soap matrix to fill the interior of the engraving with the charcoal powder, a step S16 of coating the surface of the inner soap matrix with the melted soap base to prevent the charcoal powder filled in the interior of the engraving from deviating from the surface of the inner soap matrix, and a step S17 of, after step S16, maintaining the inner soap matrix at a room temperature for 30 minutes to 24 hours.

In step S11, an essential oil or a natural plant extract may be mixed, and in step S12, the frame may have various shapes and sizes of a circular, a rectangular shape, a triangular shape, a star shape, or an animal shape.

In step S13, the message may be engraved twice at power of 13 W to 18W and at the engraving speed of 500 mm/s by using a CO₂ laser.

Step S2 may include a step S21 of introducing a crystal transparent soap base in a solid state on sale into the double boiler and heating and melting the crystal transparent soap base, a step S22 of, after step S21, removing a soap film formed on the outer surface of the melted matter of the outer soap part, and a step S23 of, after step S22, if the temperature of the melted matter of the outer soap part reaches 50 C, removing foreign substances by using a sieve.

In step S21, when about two thirds of the soap base is melted, additives of oil, perfume, or natural plant powder may be introduced and may be melted by residual heat.

Step S3 may include a step of locating the transparent inner soap part, in which the message is engraved, in the interior of a lower mold of silicon prepared separately, a step of passing a plurality of fixing pins including an elastic metallic material through a side wall of the lower mold such that the front ends of the fixing pins are inserted into one side wall or a radial outer wall of the inner soap part, and fixedly supporting the inner soap part in a state in which the inner soap part is suspended in the air in the lower mold by the fixing pins, a step of spraying ethanol on the outer surface of the inner soap part in a state in which the inner soap part is fixedly supported to be suspended in the air in the lower mold, a step of coupling a separately prepared upper mold having opened top and bottom sides onto the lower mold, a step of pouring the melted matter of the outer soap part prepared in advance while undergoing step S2 through the opened upper side of the upper mold in a state in which the upper mold is coupled onto the lower mold, a step of, after 15 minutes or 20 minutes elapse since the melted matter of the outer soap part are filled in the interiors of the lower mold and the upper mold, removing the fixing pins from the inner soap part, a step of, after the coupling of the inner soap part and the outer soap part are slowly and sufficiently solidified at a room temperature after the fixing pins are removed, polishing an upper portion of the outer soap part thin, and a step of polishing and cleaning the surface of the coupling.

In the step of pouring the melted matter of the outer soap part, the melted matter may be poured while being uniformly sprayed by using a separate tool.

In the step of removing the fixing pins from the inner soap part, the fixing pins may be removed while being shaken upwards, downwards, leftwards, and rightwards to prevent bubbles from being generated in the interior of the inner soap part, to which the fixing pins are stuck, and to eliminate marks.

In accordance with another aspect of the present invention, there is provided a transparent soap produced by the method and formed by integrally coupling the transparent outer soap part to the inner soap part in a form in which the transparent outer soap part surrounds the outer surface of the inner outer soap part having the message on the surface thereof.

As described above, according to the transparent soap produced according to the present invention, the external appearance of the transparent soap is appealing and the message, such as a letter, a pattern, a figure, and a picture, which is realized on the surface of the inner soap part (ISP) provides an excellent 3-dimensional visibility, and an effect of stimulating the curiosity of the consumers and an effect of delivering information can be achieved.

### BRIEF DESCRIPTION OF THE DRAWINGS

The above and other objects, features, and advantages of the present invention will be more apparent from the following detailed description taken in conjunction with the accompanying drawings, in which:

FIG. 1 is a flowchart of a process for producing a transparent soap according to a preferred embodiment of the present invention;

FIG. 2 is a view illustrating the structure of a mold for producing a transparent soap according to a preferred embodiment of the present invention;

FIG. 3 illustrates views sequentially illustrating a process of producing a transparent soap by using a mold for producing a transparent soap according to a preferred embodiment of the present invention; and

FIG. 4 is a real picture of a transparent soap produced according to a preferred embodiment of the present invention.

### DETAILED DESCRIPTION OF THE EXEMPLARY EMBODIMENTS

Hereinafter, a transparent soap having a 3-dimensional message displaying function and a method for producing the same according to preferred embodiments of the present invention will be described in detail with reference to the accompanying drawings.

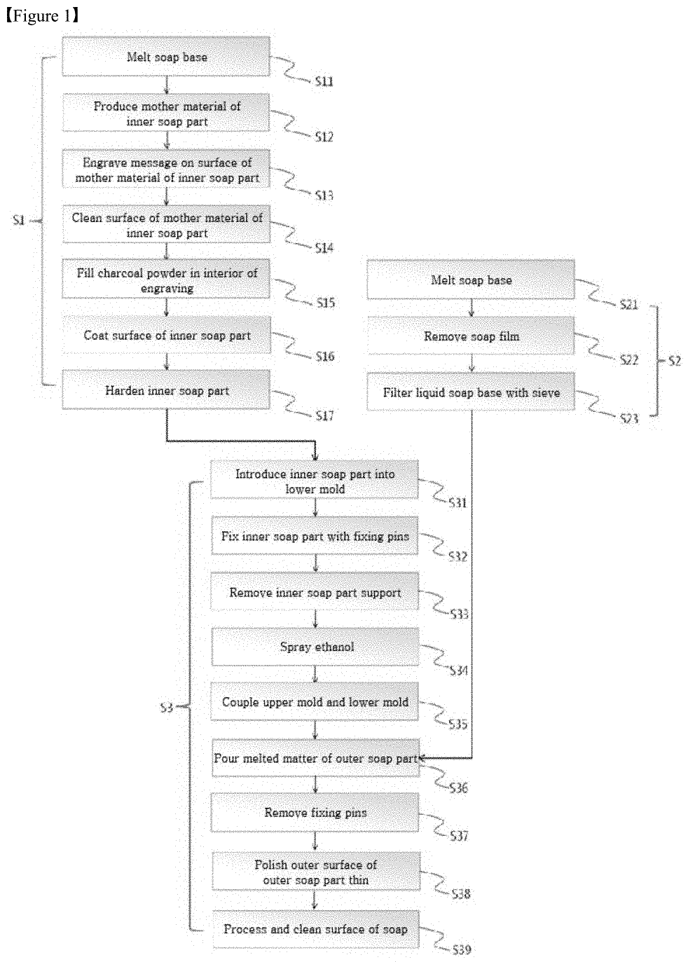

FIG. 1 illustrates a process of producing a transparent soap having a 3-dimensional message displaying function according to a preferred embodiment of the present invention in several stages.

Referring to FIG. 1, in order to produce a transparent soap having a 3-dimensional message displaying function according to the present invention, a transparent inner soap part is made first (=step S1).

In a more detailed description of the step of making the transparent inner soap part, a natural white soap base on sale, for example, an MP white soap base in a solid state on sale is purchased, is introduced into a double boiler prepared in advance, and is melted (=step S11). When the soap base is melted, various functional materials may be added if necessary. For example, an essential oil that is extracted from several parts, such as flowers, fruits, steps, and roots of plants, may be mixed, or natural plant extracts, such as green tea sprouts, Glycyrrhiza uralensis Fischer, and the like may be mixed. If the essential oil is used as a spice, effects of preventing and suppressing skin diseases such as atopic dermatitis as well as a moisture effect can be obtained. It will be easily understood by an ordinary person in the art to which the present invention pertains that various soaps, for example, for atopic dermatitis, dry skin, and oily skin can be manufactured, and various natural materials that can show characteristics, such as whitening, moisturizing, cleansing, prevention of skin aging, removal of dead skin cell, and a calming effect can be mixed.

Next, the soap base in a melted liquid state is poured into a frame of a desired size, and is solidified at a room temperature for two or three days to generate an inner soap matrix having various shapes (=step S12). Then, the frame may be manufactured to have various shapes, such as a circular shape, a rectangular shape, a triangular shape, a star shape, and an animal shape, and various sizes. Accordingly, it will be easily understood by an ordinary person in the art to which the present invention pertains that the inner soap matrix according to the present invention can be made to have various sizes and various shapes.

If the inner soap matrix having the shape is made, a message is engraved on a surface of the inner soap matrix. In detail, the outer surface of the inner soap matrix is machined by a laser machine programmed in advance, and preferably, a desired letter, a desired shape, or a desired image is engraved on a front surface of the inner soap matrix (=step S13). The laser engraving operation is performed twice by using a CO₂ laser while an engraving speed of 500 mm/s and a strength of a range of 13 to 22 at power of 13 W to 18 W.

If the laser machining is finished, a cleaning process of removing foreign substances, such as soap powder, which resides on a surface of the inner soap matrix, on which the message is engraved, is performed by using an bonding tape, or wiping the surface of the inner soap material by using a water tissue (=step S14).

If the surface of the inner soap matrix is completely cleaned, charcoal powder is poured onto the outer surface of the inner soap matrix, on which the message is engraved, to fill the interior of the engraving (=step S15). After a sufficient amount of charcoal powder is uniformly filled in the interior of the engraving, in order to prevent the charcoal powder filled in the interior of the engraving from deviating from the surface of the inner soap matrix, a surface coating operation of pouring the soap base in the melted liquid state, as described above, onto the surface of the inner soap matrix with a thickness of about 1 mm (=step S16). Next, the transparent inner soap part, on which the message is engraved, is maintained at a room temperature for 30 minutes to 24 hours and is hardened (=step S17). The transparent inner soap part having a message is made via the process.

Meanwhile, although the method for expressing a letter, a shape, or an image by engraving the outer surface of the inner soap matrix and the engraving is filled with charcoal powder has been described until now, it will be easily understood by an ordinary person in the art to which the present invention pertains that a letter, a shape, or an image may be expressed by attaching a printing matter, on which an image or a letter of a natural substance having a bonding property is printed, to the outer surface of the inner soap matrix. For example, a message may be provided by attaching a sticker, on which a letter, a feature, or an image is printed, preferably, a tattoo sticker to the outer surface of the inner soap matrix.

Separately from the process of preparing the transparent inner soap part having a message, a transparent outer soap part in a melted state, which will be coupled to the outer surface of the inner soap part to be integrally formed with the inner soap part is made (=step S2).

In a more detailed description of the step of making the outer soap part, a melted matter of the outer soap part in a liquid state is prepared by introducing a crystal transparent soap base in a solid state on sale into a double boiler, and heating and melting the crystal transparent soap base. When two thirds of the crystal transparent soap base is melted, additives, such as oil, spices, natural plant powder, are added and are melted by residual heat (=step S21).

If the melted matter of the outer soap part is slightly cooled after step S21, a soap film is generated on the surface of the melted matter of the outer soap part, and then the soap film is removed (=step S22). If the temperature of the melted matter of the outer soap part reaches about 50 c, foreign substances are removed by using a sieve (=step S23). The melted matter of the outer soap part is prepared via the process.

Meanwhile, as described above, if the inner soap part having a message is prepared, the outer soap part is coupled to the inner soap part to surround the outer surface of the inner soap part and the inner soap part and the outer soap part are integrally formed with each other (=step S3).

The inner soap part and the outer soap part are integrally formed with each other by using a mold designed uniquely according to the present invention.

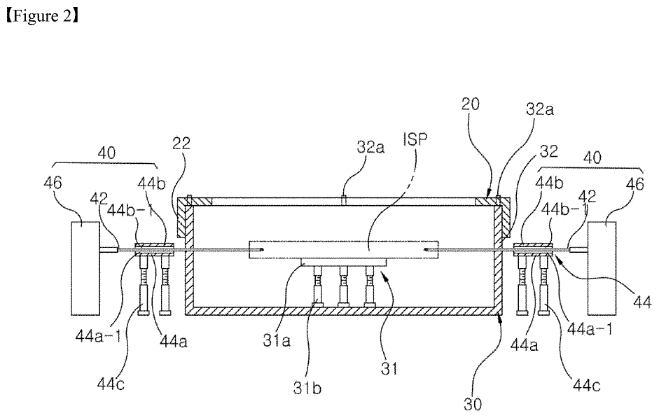

FIG. 2 is a view illustrating the structure of a mold for producing a transparent soap according to a preferred embodiment of the present invention.

Referring to FIG. 2, the mold 10 for producing a transparent soap includes an upper mold 20 and a lower mold 30 that are produced of silicon, into which a needle may penetrate, and the upper mold 20 includes four upper mold side walls 22 on the four sides, and the top and the bottom of the upper mold 20 are opened.

The lower mold 30 includes four lower mold side walls 32 on the four sides, and the top of the lower mold 30 is opened and the bottom of the lower mold 30 is closed. Coupling protrusions 32a protrude vertically upwards from corners, at which the lower mold side walls 32 meet each other, or intermediate portions of the corners, and through-holes (not illustrated) for accommodating the coupling protrusions 32a are formed on the lower surfaces of the upper mold side walls 22 in correspondence to the coupling protrusions 32a. The upper mold 20 and the lower mold 30 may be coupled to each other integrally and firmly in a manner in which the coupling protrusions 32a are inserted into the through-holes.

An inner soap part support 31 is disposed in the interior of the lower mold 30 to be removed. The inner soap part support 31 includes a horizontal plate 31a for supporting the inner soap part (ISP), and a plurality of vertical columns 31a that extend such that the lengths from the lower surface of the horizontal plate 31a are adjusted.

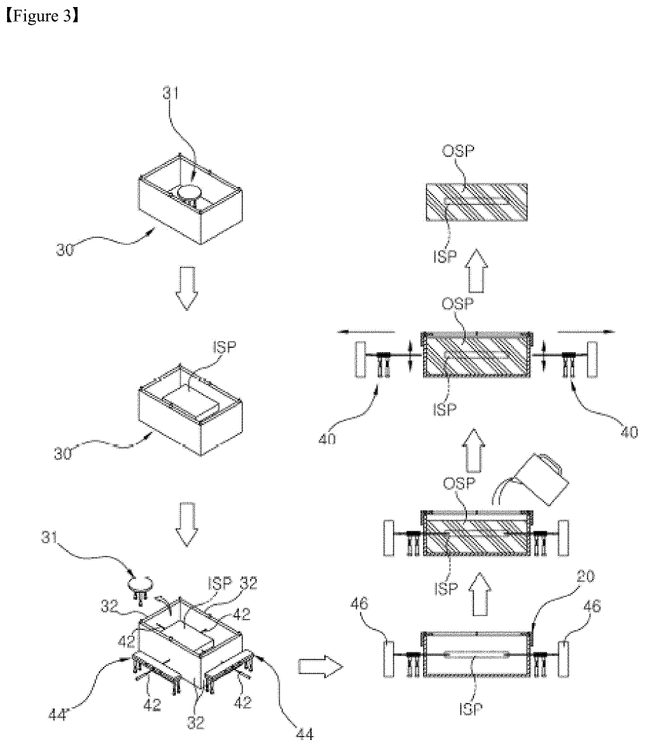

Inner soap part fixing kits 40 for temporarily fixedly supporting the inner soap part when the transparent outer soap part (OSP) (see FIG. 3) in a liquid state is poured to the upper and lower sides and the four outsides of the inner soap part (ISP) disposed in the interior of the lower mold 30 are disposed.

Each of the inner soap part fixing kits 40 includes a fixing pin 42, a fixing pin holder 44, and a vibrator 46. The fixing pin 42 is produced of an elastic metal, which may penetrate into the lower mold side wall 32 formed of silicon. Preferably, the fixing pin 42 is a needle having a diameter of 1 mm or less. In order to fixedly support the inner soap part, the fixing pin 42 is inserted to penetrate the lower mold side wall 32 from the outside to the inside of the lower mold side wall 32, and accordingly, a portion of the fixing pin 42 is exposed to the interior of the lower mold 30 and another portion of the fixing pin 42 is exposed to the outside. An outer end of the fixing pin 42 exposed to the outside is fixedly supported by a fixing pin holder 44, a lower portion of which is supported by the ground surface.

The fixing pin holder 44 includes a plate-shaped holder body 44a, a holder cover 44b coupled to the upper surface of the holder body 44a to be detachable, and holder legs 44c that extend vertically downwards from the holder body 44a. A first guide groove 44a-1 for accommodating and supporting a portion of the fixing pin 42 is formed on the upper surface of the holder body 44a. In correspondence, a second guide groove 44b-1 for accommodating and supporting a radial exposure surface of the fixing pin 42 inserted into and disposed in the first guide groove 44a-1 is formed on the lower surface of the holder cover 44b. The holder legs 44c are formed such that the lengths thereof may be adjusted along a vertical direction.

The vibrator 46 is mechanically connected to the rear end of the fixing pin 42 accommodated and disposed between the holder body 44a and the holder cover 44b. A recess (not illustrated), in which a rear end of the fixing pin 42 may be accommodated, is formed in the body (reference numeral omitted) of the vibrator 46. The vibrator 46 is operated by electric power supplied from an external power source (not illustrated).

FIG. 3 illustrates views sequentially illustrating a process of producing a transparent soap by using a mold for producing a transparent soap according to a preferred embodiment of the present invention.

Referring to FIGS. 1 and 3, the process of integrally forming the inner soap part and the outer soap part by using the mold 10 for producing a transparent soap according to the preferred embodiment of the present invention will be described as follows.

First, the inner soap part support 31 is located at a central location of the interior of the lower mold 30. Next, the transparent inner soap part (ISP), in which a message is engraved, is located on the horizontal plate 31b of the inner soap part support 31 (=step S31).

In this state, the fixing pins 42 disposed on the left and right sides or the front and rear sides of the lower mold side wall 32, among the fixing pins 42 of the inner soap part fixing kits disposed on the four outsides of the lower mold side wall 32, penetrate into the lower mold side wall 32, and the front ends of the fixing pins 42 are inserted into the one side wall or the radial outer wall of the inner soap part (ISP). Then, the fixing pins 42 are fixed to be supported in place by the fixing pin holder 44 (=step S32).

If the inner soap part (ISP) is fixedly supported first in the interior space of the lower mold 30 by two fixing pins 42, among the four fixing pins 42, the inner soap part support 31 is picked out by a hand and is removed from the lower mold 30 (=step S33). Next, the remaining two fixing pins 42 penetrate into the lower mold side wall 32, and the front ends of the fixing pins 42 are located to be inserted into one side wall or the radial outer wall of the inner soap part (ISP). As a result, the inner soap part (ISP) is fixedly supported while being suspended in the air in the lower housing 30 by the four fixing pins 42.

In a state in which the inner soap part (ISP) is fixed while being suspended in the air in the lower mold 30, foreign substances stuck to the outer surface of the inner soap part (ISP) are removed and ethanol is sprayed to remove bubbles at the same time (step S34). Similarly, ethanol is additionally sprayed to the inner surface of the lower mold 30 to remove foreign substances and bubbles that reside in the interior of the lower mold 30.

After step S34, the lower mold 20 is coupled onto the lower mold 30 (=step S35). In a state in which the upper mold 20 is coupled onto the lower mold 30, the melted matter of the outer soap part prepared in advance via step S2 is poured through the opened top of the upper mold 20 (=step S36). Bubbles are prevented from being generated by pouring the melted matter of the outer soap part while uniformly spraying the melted matter of the outer soap part by using a separate tool, such as a spoon, when the melted matter of the outer soap part is poured.

if 15 to 20 minutes elapse after the melted matter of the outer soap part is filled in the interiors of the lower mold 30 and the upper mold 20, the fixing pins 42 of the inner soap part fixing kit 40 are removed from the inner soap part (ISP) (=step S37). When the fixing pins 42 are removed from the inner soap part (ISP), they are shaken upwards, downwards, leftwards, and rightwards to prevent bubbles from being generated in the interior of the inner soap part (ISP), to which the fixing pins 432 have been stuck, and to eliminate marks. To achieve this, the vibrator 46 mechanically connected to the outer ends of the fixing pins 42 is operated to move the fixing pin holder 44 far away from the lower mold side walls 32 while vibrating the fixing pins 42 upwards, downwards, leftwards, and rightwards and remove the fixing pins 42 from the inner soap part (ISP). This can prevent needle marks from being generated in the inner soap part (ISP) by the fixing pins 42 that have gripped the inner soap part (ISP) or bubbles from being generated accordingly.

After the fixing pins 42 are removed from the inner soap part (ISP), the coupling of the inner soap part and the outer soap part are slowly and sufficiently solidified at a room temperature, and the upper side of the outer soap part (OSP) is polished thin to remove the bubbles raised to the upper side of the outer soap part (OSP) (=step S38).

Finally, the surface of the soap is machined and cleaned by using a soap plane and a water tissue (=step S39) to finish the transparent soap having a message displaying function.

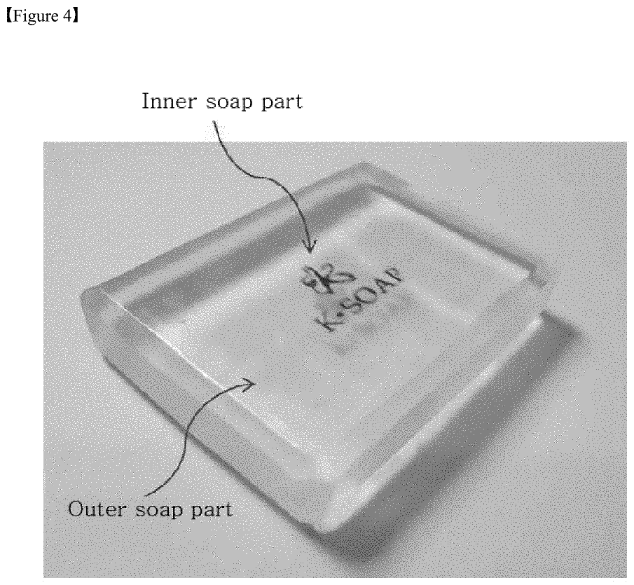

FIG. 4 illustrates a real picture of the transparent soap according to the present invention in which the outer soap part is coupled to the outside of the inner soap part and is integrally formed with the inner soap part to surround the inner soap part finally via the above processes.

As illustrated in FIG. 4 well, because the inner soap part (ISP) and the outer soap part (OSP) are integrally formed with each other such that a border thereof cannot be recognized by naked eyes according to the transparent soap produced of the present invention, the external appearance of the transparent soap is appealing and the message, such as a letter, a pattern, a figure, and a picture, which is realized on the surface of the inner soap part (ISP) provides an excellent 3-dimensional visibility, and an effect of stimulating the curiosity of the consumers and an effect of delivering information can be achieved.

The above description is a simple exemplification of the technical spirit of the present invention, and the present invention may be variously corrected and modified by those skilled in the art to which the present invention pertains without departing from the essential features of the present invention. Therefore, the disclosed embodiments of the present invention do not limit the technical spirit of the present invention but are illustrative, and the scope of the present invention is not limited by the embodiments of the present invention. The scope of the present invention should be construed by the claims, and it will be understood that all the technical spirits within the equivalent range are fall within the scope of the present invention.

### FIGURE

S11: Melt soap base
S12: Produce mother material of inner soap part
S13: Engrave message on surface of mother material of inner soap part
S14: Clean surface of mother material of inner soap part
S15: Fill charcoal powder in interior of engraving
S16: Coat surface of inner soap part
S17: Harden inner soap part
S21: Melt soap base
S22: Remove soap film
S23: Filter liquid soap base with sieve
S31: Introduce inner soap part into lower mold
S32: Fix inner soap part with fixing pins
S33: Remove inner soap part support
S34: Spray ethanol
S35: Couple upper mold and lower mold
S36: Pour melted matter of outer soap part
S37: Remove fixing pins
S38: Polish outer surface of outer soap part thin
S39: Process and clean surface of soap

What is claimed is:

1. A method for producing a transparent soap having a 3-dimensional message displaying function, the method comprising:
a step S1 of making a transparent inner soap part having a message;
a step S2 of making an melted transparent outer soap part that is to be coupled to an outer surface of the inner soap part to be integrally formed with the inner soap part; and
a step S3 of coupling the outer soap part to the inner soap part such that the outer soap part surrounds the outer surface of the inner soap part and integrally forming the outer soap part with the inner soap part.

2. The method of claim 1, wherein in step S1, the message is a printing matter in which an image or a letter of a natural substance, which has a bonding property is printed such that the message is attached to the outer surface of the inner soap part.

3. The method of claim 1, wherein step S1 comprises:
a step S11 of introducing a natural white soap base on sale into a double boiler, and heating the double boiler to melt the natural white soap base;
a step S12 of introducing the melted soap base into a specific frame and solidifying the melted soap base at a room temperature for two or three days to generate an inner soap matrix;
a step S13 of engraving a message on a surface of the generated inner soap matrix by using a laser machine programmed in advance;
a step S14 of removing foreign substances residing on the surface of the inner soap matrix, on which the message is engraved;
a step S15 of, after step S14, pouring charcoal powder onto the outer surface of the inner soap matrix to fill the interior of the engraving with the charcoal powder;
a step S16 of coating the surface of the inner soap matrix with the melted soap base to prevent the charcoal powder filled in the interior of the engraving from deviating from the surface of the inner soap matrix; and
a step S17 of, after step S16, maintaining the inner soap matrix at a room temperature for 30 minutes to 24 hours.

4. The method of claim 3, wherein in step S11, an essential oil or a natural plant extract is mixed, and
wherein in step S12, the frame has various shapes and sizes of a circular, a rectangular shape, a triangular shape, a star shape, or an animal shape.

5. The method of claim 3, wherein in step S13, the message is engraved twice at power of 13 W to 18 W and at the engraving speed of 500 mm/s by using a CO₂ laser.

6. The method of claim 1, wherein step S2 comprises:
a step S21 of introducing a crystal transparent soap base in a solid state on sale into the double boiler and heating and melting the crystal transparent soap base;
a step S22 of, after step S21, removing a soap film formed on the outer surface of the melted matter of the outer soap part; and
a step S23 of, after step S22, if the temperature of the melted matter of the outer soap part reaches 50 C, removing foreign substances by using a sieve.

7. The method of claim 6, wherein in step S21, when about two thirds of the soap base is melted, additives of oil, perfume, or natural plant powder are introduced and are melted by residual heat.

8. The method of claim 1, wherein step S3 comprises:
a step of locating the transparent inner soap part, in which the message is engraved, in the interior of a lower mold of silicon prepared separately;
a step of passing a plurality of fixing pins comprising an elastic metallic material through a side wall of the lower mold such that the front ends of the fixing pins are inserted into one side wall or a radial outer wall of the inner soap part, and fixedly supporting the inner soap part in a state in which the inner soap part is suspended in the air in the lower mold by the fixing pins;
a step of spraying ethanol on the outer surface of the inner soap part in a state in which the inner soap part is fixedly supported to be suspended in the air in the lower mold;
a step of coupling a separately prepared upper mold having opened top and bottom sides onto the lower mold;
a step of pouring the melted matter of the outer soap part prepared in advance while undergoing step S2 through the opened upper side of the upper mold in a state in which the upper mold is coupled onto the lower mold;
a step of, after 15 minutes or 20 minutes elapse since the melted matter of the outer soap part are filled in the interiors of the lower mold and the upper mold, removing the fixing pins from the inner soap part;
a step of, after the coupling of the inner soap part and the outer soap part are slowly and sufficiently solidified at a room temperature after the fixing pins are removed, polishing an upper portion of the outer soap part thin; and
a step of polishing and cleaning the surface of the coupling.

9. The method of claim 8, wherein in the step of pouring the melted matter of the outer soap part, the melted matter is poured while being uniformly sprayed by using a separate tool.

10. The method of claim 8, wherein in the step of removing the fixing pins from the inner soap part, the fixing pins are removed while being shaken upwards, downwards, leftwards, and rightwards to prevent bubbles from being generated in the interior of the inner soap part, to which the fixing pins are stuck, and to eliminate marks.

11. A transparent soap produced by the method of claim 1, and formed by integrally coupling the transparent outer soap part to the inner soap part in a form in which the transparent outer soap part surrounds the outer surface of the inner outer soap part having the message on the surface thereof.

12. A transparent soap produced by the method of claim 2, and formed by integrally coupling the transparent outer soap part to the inner soap part in a form in which the transparent outer soap part surrounds the outer surface of the inner outer soap part having the message on the surface thereof.

13. A transparent soap produced by the method of claim 3, and formed by integrally coupling the transparent outer soap part to the inner soap part in a form in which the transparent outer soap part surrounds the outer surface of the inner outer soap part having the message on the surface thereof.

14. A transparent soap produced by the method of claim 4, and formed by integrally coupling the transparent outer soap part to the inner soap part in a form in which the transparent outer soap part surrounds the outer surface of the inner outer soap part having the message on the surface thereof.

15. A transparent soap produced by the method of claim 5, and formed by integrally coupling the transparent outer soap part to the inner soap part in a form in which the transparent outer soap part surrounds the outer surface of the inner outer soap part having the message on the surface thereof.

16. A transparent soap produced by the method of claim 6, and formed by integrally coupling the transparent outer soap part to the inner soap part in a form in which the transparent outer soap part surrounds the outer surface of the inner outer soap part having the message on the surface thereof.

17. A transparent soap produced by the method of claim 7, and formed by integrally coupling the transparent outer soap part to the inner soap part in a form in which the transparent outer soap part surrounds the outer surface of the inner outer soap part having the message on the surface thereof.

18. A transparent soap produced by the method of claim 8, and formed by integrally coupling the transparent outer soap part to the inner soap part in a form in which the transparent outer soap part surrounds the outer surface of the inner outer soap part having the message on the surface thereof.

19. A transparent soap produced by the method of claim 9, and formed by integrally coupling the transparent outer soap part to the inner soap part in a form in which the transparent outer soap part surrounds the outer surface of the inner outer soap part having the message on the surface thereof.

20. A transparent soap produced by the method of claim 10, and formed by integrally coupling the transparent outer soap part to the inner soap part in a form in which the transparent outer soap part surrounds the outer surface of the inner outer soap part having the message on the surface thereof.
